(19) United States
(12) Patent Application Publication
(10) Pub. No.: US 2003/0084006 A1
(43) Pub. Date: May 1, 2003

(54) Smart business manager cost predictor

(76) Inventor: George Bradley Hobbs, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 10/002,761

(22) Filed: Oct. 29, 2001

(51) Int. Cl. G06F 17/00; G06G 7/00

(52) U.S. Cl. 705/400

(57) ABSTRACT

A method and system for predicting postage and consumables costs for a print job prior to production of a hardcopy, wherein the print job includes a set of predefined attributes which may be used to predict the weight and size of a print job. A postage rate scale for a chosen carrier may then be applied to determine the postage or shipping cost. Similarly, the print job attributes are used to predict the consumables cost to produce a hardcopy of the print job. The consumables cost thus may be combined with the postage cost to determine the total cost of production and mailing of a hardcopy.

### TECHNICAL FIELD

The invention relates generally to print jobs, and more particularly, to a system and method for regulating the postage and consumables costs associated with producing and mailing of physical hardcopies of print jobs.

### BACKGROUND OF THE INVENTION

Computer users today are able to generate sophisticated electronic documents that may be suitable for a variety of high-end printers employing different printing technologies. Often, hardcopies of sophisticated electronic documents are distributed by mail, such as in direct mail advertisements. Managers and document creators, especially in the direct mailing field, would benefit from knowledge about the postage costs associated with selecting certain printer technologies, media types, and formatting options. However, the postage costs associated with mailing documents printed with different printer technologies, on different media types, and using different formatting options is largely unknown prior to weighing a hardcopy of the document. For example, most offices have a scale and postage meter to determine the postage after the document is ready for mailing. It would be desirable to provide the document creator with the ability to predict postage costs for different formatting, printer, and media selections. This is especially true for high volume jobs where a large number of copies are being mailed.

Additionally it will be appreciated that, different printer technologies use different amounts of ink, or toner, and have different costs associated with the printing. Furthermore, different media types are more or less expensive than others. These costs combine with the costs of any envelopes or binding materials to provide a consumables cost. The types of consumables selected may in turn affect the postage costs. It would be useful for managers and document creators to be able to easily compare the variations in consumable costs and postage costs for the various printer technologies, media types, and binding options at the time the electronic document is being designed.

To best understand the total cost associated with production and mailing of a hardcopy of a sophisticated electronic document, information about the postage cost and consumables cost is desirable at the selections stage of the various options so that the costs can be evaluated at the time the electronic document is designed.

### SUMMARY OF THE INVENTION

The present invention provides a method and a system for predicting postage and consumables costs for a print job prior to production of a hardcopy. The print job includes a set of predefined attributes which may be used to predict the weight and size of the print job. A postage rate scale for a chosen carrier may then be applied to determine the postage or shipping cost. Similarly, the print job attributes may be used to predict the consumables cost to produce a hardcopy of the print job. The consumables cost thus may be combined with the postage cost to determine the total cost of production and mailing of a hardcopy.

### BRIEF DESCRIPTION OF THE DRAWINGS

FIG. 1 is a networked computer system in which one embodiment of the present invention may be implemented.

FIG. 2 is a schematic depiction of a computer in the networked computer system of FIG. 1.

FIG. 3 is a graphical user interface of one embodiment of the present invention.

FIG. 4 is a flowchart of a method for enabling the user to select document attributes to cost-optimize a print job.

### DETAILED DESCRIPTION OF THE INVENTION

The present invention provides a method and system for estimating the postage and consumables costs for printing and sending a hardcopy of an electronic print job, and displaying those costs to a user prior to producing the hardcopy.

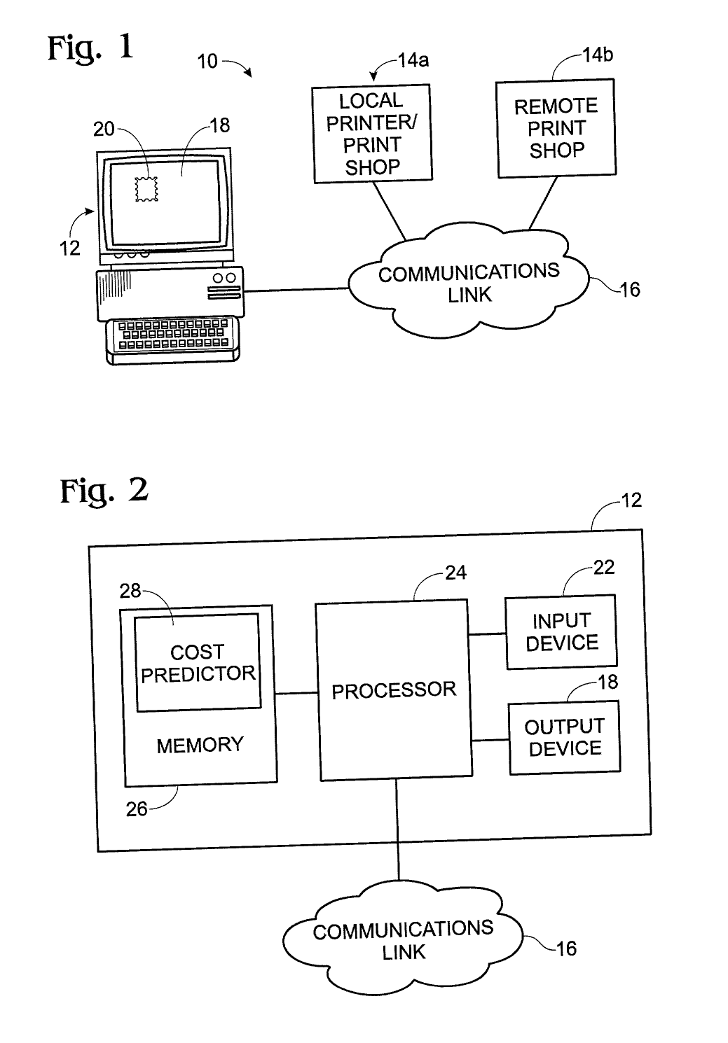

A network system 10 for carrying out the present invention is shown in FIG. 1. The network system includes a computer 12, a local print shop 14a, a remote print shop 14b, and a communications link 16. In accordance with the present invention the depicted network system uses computer 12 to evaluate an electronic print job to predict postage and consumable costs. The electronic print job may be created in another application on computer 12.

Computer 12 may have a display monitor 18 that includes icons representing applications that are configured to run on computer 12. A representative cost predictor icon 20 is positioned on display monitor 18 in the depicted embodiment. When a user selects icon 20, computer 12 executes the method of the present invention, as will be explained below.

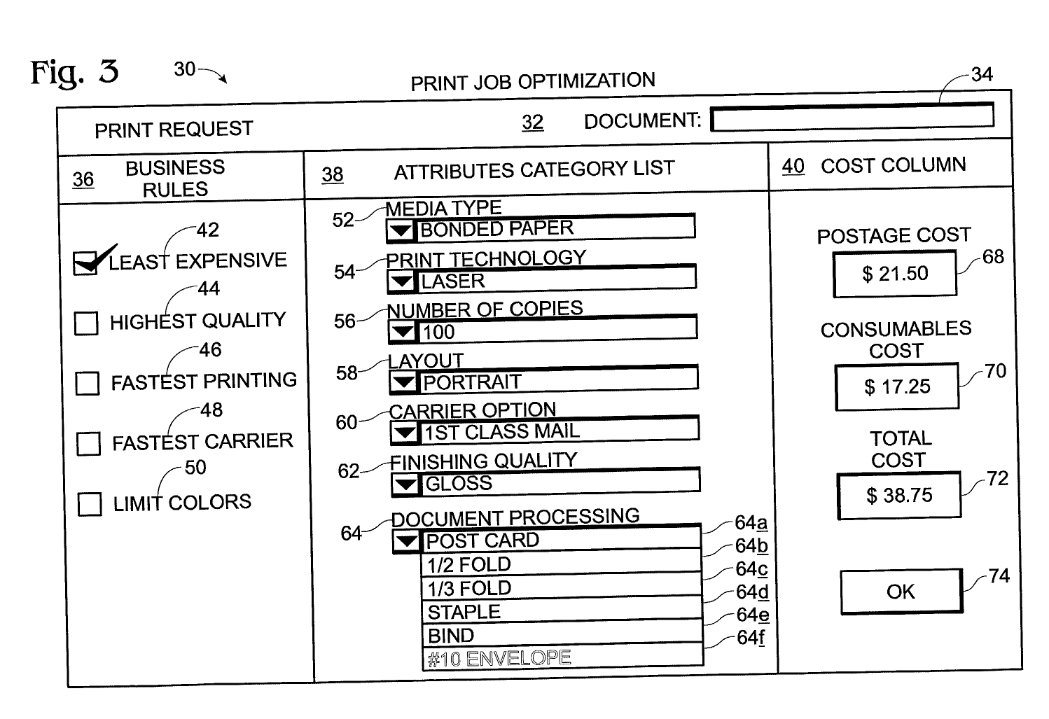

FIG. 2, shows, in more detail, how computer 12 of network system 10 may be configured. In this example, computer 12 includes an output device 18, an input device 22, a processor 24, a communications link 16, and memory 26. A cost predictor 28 is stored on memory 26, and is configured to run on processor 24, interacting with input device 22, output device 18, and communications link 16. Other suitable devices may be used according to the present invention, including, but not limited to, personal digital assistants, handheld computers, cell phones, laptop computers, etc.

Communications link 16 is any set of connections that allows communication between computer 12 and a printer or print shop. The communications link may be configured as a local area network, for example, a network within an office or company. Alternatively, the communications link may be a global communications network, such as the Internet. In yet another example, communications link 16 may be a dial-up connection. Additionally, communications link 16 may be a wireless network or integrated wireless and wired network. Any suitable computer communications technology presently known, or in the future developed, is within the scope of communications link 16.

Print shop 14a is shown as a local print shop, which may take the form of an on-site print shop, or represent on-site printing capabilities. Print shop 14b is shown as a remote print shop, which may take the form of an off-site print shop, offering full-service printing capabilities.

As noted above user-selection of icon 20 causes processor 24 to execute cost predictor 28. Upon such execution, an interface screen 30 appears on output device 18, as shown in FIG. 3. In the depicted embodiment, interface screen 30 is divided into an identification header 32 (including a document identification field 34), a business rules menu 36, an attributes category list 38, and a cost column 40.

Cost predictor 28 requires the user to identify a print job to be evaluated. The user may type in the print job identification, or alternatively, the user may request execution of cost predictor 28 from within another application. When cost predictor 28 is executed from within another application the active electronic document from the other application may be automatically entered into print job identification field 34, and the known print job attributes imported into the appropriate attribute categories in attribute category list 38.

Business rules menu 36 includes a series of user-selectable rules, each configured to direct selection of attributes of the electronic document according to an objective of the corresponding business rule. In the depicted embodiment, the business rules menu includes a “Least Expensive” rule 42, a “Highest Quality” rule 44, a “Fastest Printing” rule 46, a “Fastest Carrier” rule 48, and a “Limit Colors” rule 50. Typically, selection of a business rule pre-sets the attributes of the print job to best accomplish the objective of the selected business rule, as will be further explained below.

“Least Expensive” rule 42 may be configured to cause evaluation of the default attributes to determine what attributes for the print job may be changed to minimize costs, and then to make those changes. “Highest Quality” rule 44 may be configured to cause evaluation of the default attributes to determine what attributes may be changed to increase the quality of the hardcopy, and then to make those changes. “Fastest Printing” rule 46 may be configured to cause evaluation of the default attributes to determine what attributes may be changed to speed up the production of the hardcopy, and then to make those changes. “Limit Colors” rule 50 may be configured to cause evaluation of the default attributes to determine the minimum number of colors required to produce a hardcopy, and then to change the attributes to use the minimum number of colors.

Attributes category list 38 includes a series of pull-down selections for each attribute category. The attribute categories included may be customized for a user's specific needs, and for the printer technologies available. In the depicted embodiment, the list of attribute categories includes “Media Type” 52, “Printer Technology” 54, “Number of Copies” 56, “Layout” 58, “Carrier Option” 60, “Finish Quality” 62, and “Document Processing” 64. The “Media Type” attribute category indicates the material that the hardcopy will be printed on (e.g., bonded paper, card stock, transparencies, etc.). The “Printer Technology” attribute category indicates the type of printer that will be used to produce the hardcopy (e.g. inkjet, laserjet, etc.). The “Number of Copies” attribute category indicates the number of copies that will be produced. The “Layout” attribute category indicates the orientation of the hardcopy (e.g. portrait or landscape), as well as number of columns, fonts, font sizes, etc. The “Carrier Option” attribute category identifies the carrier for mailing or shipping purposes (e.g. FEDEX, U.S. Mail, UPS, etc.). The “Finish Quality” attribute category indicates the type of finish that will be used for the hardcopy (e.g. glossy, flat, etc.). The “Document Processing” attribute category indicates the post-printing processes that the document may be subjected to (e.g., stapling, folding, or binding, etc.).

Cost predictor 28 examines the print job to discern all of the available predefined attributes contained in the print job. If the print job does not have all of the required attributes for making a cost calculation, the cost predictor will prompt the user to select from the available choices of a pull-down menu in each of the respective attribute categories. For example, in connection with document processing attribute category 64, the user may be prompted to select from a pull-down list of attributes for document processing, such as: “post card” 64a; “½ fold” 64b; “⅓ fold” 64c; “staple” 64d; “bind” 64e; and “#10 envelope” 64f. Some attributes may be grayed out if they are incompatible with predefined attributes contained in the print job. For example, if the print job has too many pages to fit in a #10 envelope, the “#10 envelope” attribute may be grayed out, as shown in FIG. 3.

Once all of the missing document attributes have been selected, a postage cost 68, a consumables cost 70, and a total cost 72 may be displayed in cost column 40. The postage cost may be determined, for example, by calculating the weight and size of the print job, and then applying a carrier rate schedule to the calculated weight and size. The carrier rate schedule is determined based on the carrier identified by the “Carrier Option” attribute category. It will be appreciated, however, that other characteristics determined from the selected attributes impact postage cost. The consumables cost may be determined by calculating the cost of the various consumables in view of the selected attributes. The total cost is determined by adding the postage cost to the consumables cost. Postage costs may be determined from a set of postage determining factors, which may include media weight, printer technology, print format, and binding options, etc. Similarly, consumables cost may be determined by a set of consumable factors, which may include media cost, binding material cost, printer technology cost, etc.

The weight of the hardcopy of the print job may be determined by accessing a database associated with each attribute category. For example, the “Media Types” attribute category may have associated therewith, a database including information such as weight, cost, durability rating, conflict warning, etc. Conflict warnings may include limitations arising as a result of selection of an attribute. For example, transparency media may not be compatible with certain printer technologies (e.g. laser).

Similarly, a printer technology attributes category database may include information relating to printing costs, ink weights, coverage ranges, as well as conflict warnings, and other information for each available printer technology. It will be appreciated that various printer technologies deposit different amounts of ink or toner and that various inks and toners have different densities. By way of example some of the variation in ink weight is illustrated in the table below:

| | Calculated Consumable Usage (grams) | | | | | |
|---|---|---|---|---|---|---|
| | | | | | Total | |
| Product | C | M | Y | K | Ink | Oil |
| Indigo | 0.082 | 0.092 | 0.075 | 0.065 | 0.314 | 0.775 |
| TurboStream ® | | | | | | |
| Canon CLC | xxx | xxx | xxx | xxx | 0.270 | 0.030 |
| 1000 ® | | | | | | |
| HP Laserjet | 0.042 | 0.033 | 0.065 | 0.070 | 0.210 | 0.000 |
| 4500 ® | | | | | | |
| HP 2000C ® | 0.077 | 0.065 | 0.050 | 0.2 | 0.392 | 0.000 |

Information such as the above ink weights maybe stored in a printer technology attribute category database and may be used to determine both consumables cost, and to estimate the weight of a physical hardcopy of the print job.

As noted above, each attribute category in attribute category list 38 may be associated with a database that contains relevant information for each attribute selection available within the attribute category. This information is used to accomplish two functions. First, the information may be used to calculate the postage and consumables costs. Second, the information may be used by the cost predictor to achieve an objective of one of the business rules. For example, the “Least Expensive” rule may select attributes that have lower costs according to the information in each database.

Cost predictor 28 thus is able to access information in the attribute category databases for use in applying a selected business rule to the print job. Each business rule, it will be recalled, may define a set of criteria for one of the various attribute categories. Cost predictor 28 evaluates the data stored in the attribute category databases to select those attributes that meet those criteria for the selected business rule.

Typically, when the user selects one of the business rules from business rule menu 36, cost predictor 28 evaluates each attribute category 52-64 in attribute category list 38 to select the overall set of attributes that best meet the criteria for the selected business rule. For example, if “Least Expensive” rule 42 is selected, cost predictor 28 reviews media type attribute 52 to select the media type that results in the lowest cost. To determine the correct media type, estimator 28 evaluates weight and cost of the available media types based on information in a media type attribute category database. The media with the lightest weight and/or lowest consumables cost typically will be selected. If there is a conflict, cost predictor 28 will compare the incremental cost of postage increases (based on additional weight) with the consumables cost of the selected media. Therefore, the estimator may select a heavier media if the additional postage cost is more than offset by the savings in consumable cost.

Next, printer technology attribute category 54 may be reviewed in a similar manner, applying the “Least Expensive” criteria to the information stored in the printer technology database. For example, cost predictor 28 may compare all of the available printer technologies to minimize the cost of postage, which is a function of the weight of ink (or toner) and coverage density of the ink (or toner). The cost predictor also may minimize the consumable cost of the ink or toner. If the print job requires color, or some other special printing requirement, some of the printer technologies may be unavailable. The conflict warning data field may be used to store this information to automatically prevent conflicts from occurring.

A similar process to optimize the print job for the selected business rule may be used for each attribute category in attribute category list 38. After all of the attributes in each attribute category in list 38 have been selected to comply with the criteria of the selected business rule, a new postage cost 68, consumables cost 70, and total cost 72 may be displayed in cost column 40.

The user may then manually override any of the attribute selections for the attribute categories in attribute category list 38 to see how changes in selected attributes affect the postage and consumables costs. Once the user is satisfied with the settings for all of the attributes of the print job, the print job may be forwarded to the print shop by selection of “O.K.” button 74.

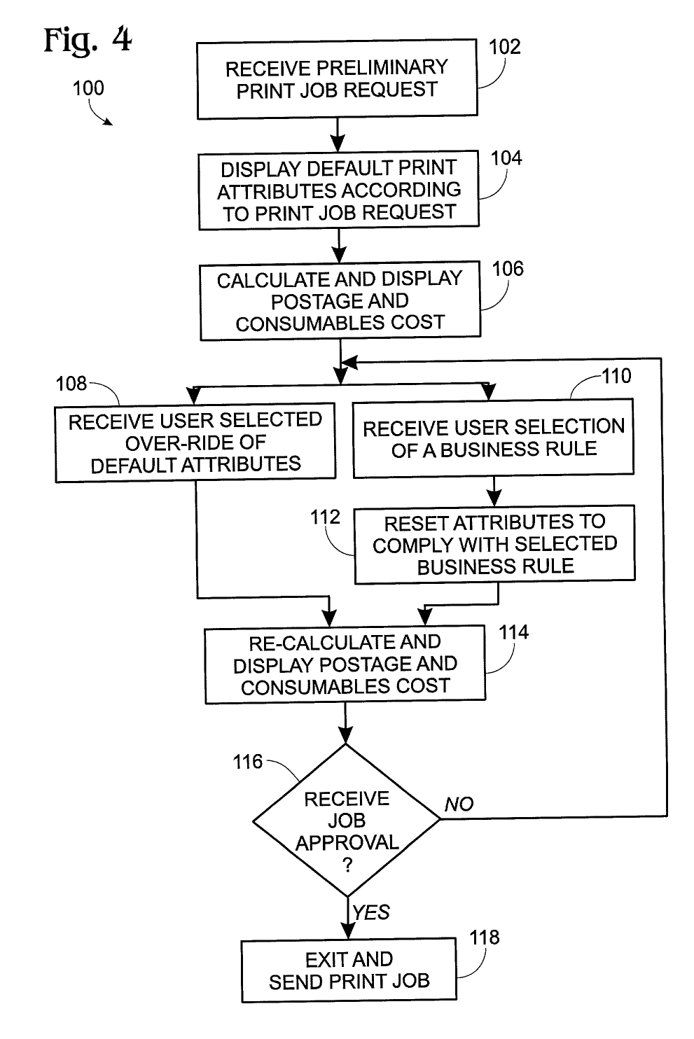

The method executed by cost predictor 28 is shown in FIG. 4, generally indicated at 100. According to method 100 cost predictor 28 receives a preliminary print request at 102. The preliminary print request includes an electronic document to be printed in hardcopy form, and may include a partial set of predefined or default attributes for the print job. Alternatively, or additionally, cost predictor 28 may itself set defaults for one or more of the attributes.

Cost predictor 28 displays the predefined or default attributes of the preliminary print request at 104. These default attributes may then be used to calculate a preliminary postage cost and a preliminary consumables cost. If a needed attribute is unavailable, the cost predictor may include the further step of requesting input of the needed attribute from a user (not shown for simplification).

Cost predictor 28 then calculates and displays the postage and consumables cost using the predefined or default attributes, at 106. Often a total cost for producing a physical hardcopy of the electronic document of the preliminary print request is also displayed. After 106, at least two possible actions may occur: 1) receipt of a user-selected override (shown at 108); or 2) receipt of a user-selected business rule (shown at 110).

If cost predictor 28 receives a user-selected to override of one of the default attributes, at 108, one or more of the default attributes is replaced with the user-selected attribute, changing the hardcopy which is to be produced. Cost predictor 28 then re-calculates the postage cost and consumables cost, as will be explained below.

If cost predictor 28 receives a user-selected business rule, as shown at 110, the cost predictor resets print job attributes based on one or more objectives of the user-selected business rule, as shown at 112. For example, as explained above, print job attributes may be reset to achieve the least expensive hardcopy, or to achieve a hardcopy of the highest possible quality. Cost predictor 28 may reset the print job attributes based on the objective of the user-selected business rule upon accessing information stored in the aforementioned databases. Cost predictor 28 then re-calculates and displays the postage cost and the consumables cost of producing the hardcopy of the print job, having the reset attributes, at 114.

Finally, cost predictor 28 checks for receipt of a job approval, at 116. If the job approval has been received, the cost predictor sends the print job for production of the hardcopy, at 118. If the job approval is not received, cost predictor 28 awaits user-selection of either an override of default attributes (at 108) or user-selection of a business rule (at 10).

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

We claim:

1. A computer-implemented method of managing print job costs, the method comprising the steps of:
providing an electronic print job request, the print job request having a set of attributes;
displaying the set of attributes;
prior to printing the print job, calculating a cost of the electronic print job using the set of attributes; and
displaying the calculated cost.

2. The method of claim 1, wherein the cost of the electronic print job includes a cost of printing.

3. The method of claim 2, wherein the cost includes estimated consumables cost based on a set of consumable factors.

4. The method of claim 3, wherein the consumable factors include one or more of media cost, binding material cost, and printer technology cost.

5. The method of claim 1, wherein the cost of the electronic print job includes a cost of mailing.

6. The method of claim 5, wherein the cost includes an estimated postage cost based on a set of postage determining factors.

7. The method of claim 6, wherein the postage determining factors include one or more of media weight, printer technology, print format, and binding options.

8. The method of claim 1, further comprising:
presenting a menu of business rules;
receiving a selection of a business rule;
modifying the set of attributes to comply with the selected business rule;
re-calculating the cost of the electronic print job using the modified set of attributes; and
displaying the re-calculated cost.

9. The method of claim 8, further comprising:
receiving a selection of an override of one or more attributes of the modified set of attributes;
re-calculating the cost of the electronic print job using the selected override of the modified set of attributes; and
displaying the newly re-calculated cost.

10. The method of claim 1, further comprising:
receiving a selection of an override of one or more attributes of the modified set of attributes;
re-calculating the cost of the electronic print job using the selected override of the modified set of attributes; and displaying the newly re-calculated cost.

11. A computer-implemented method of managing print job postage costs, the method comprising the steps of:
receiving an electronic print job request, the print job having a set of attributes;
calculating a preliminary cost of the print job using the set of attributes;
presenting a menu of business rules;
receiving a selection of one of the business rules;
adjusting the set of attributes in response to the selection of one of the business rules; and
calculating a final cost based on the adjusted set of attributes.

12. The method of claim 11, which further comprises displaying the final cost.

13. A program storage device readable by a processor, tangibly embodying a program of instructions executable by the processor to perform method steps for managing print job costs, the method steps comprising:
providing an electronic print job request, the print job request having a set of attributes;
displaying the set of attributes;
prior to printing the print job, calculating a cost of the electronic print job using the set of attributes; and
displaying the calculated cost.

14. The program storage device of claim 13, wherein the method further comprising:
presenting a menu of business rules;
receiving a selection of a business rule;
modifying the set of attributes to comply with the selected business rule;
re-calculating the cost of the electronic print job using the modified set of attributes; and
displaying the re-calculated cost.

15. The program storage device of claim 14, wherein the method further comprising:
receiving a selection of an override of one or more attributes of the modified set of attributes;
re-calculating the cost of the electronic print job using the selected override of the modified set of attributes; and
displaying the newly re-calculated cost.

16. The program storage device of claim 14, further comprising:
receiving a selection of an override of one or more attributes of the modified set of attributes;
re-calculating the cost of the electronic print job using the selected override of the modified set of attributes; and
displaying the newly re-calculated cost.

17. A program storage device readable by a processor, tangibly embodying a program of instructions executable by the processor to perform method steps for managing print job costs, the method steps comprising:
receiving an electronic print job request, the print job having a set of attributes;
calculating a preliminary cost of the print job using the set of attributes;
presenting a menu of business rules;
receiving a selection of one of the business rules;
adjusting the set of attributes in response to the selection of one of the business rules; and
calculating a final cost based on the adjusted set of attributes.

18. The program storage device of claim 17, which further comprises displaying the final cost.
